(19) United States
(12) Patent Application Publication
(10) Pub. No.: US 2005/0041895 A1
(43) Pub. Date: Feb. 24, 2005

(54) Rack thrust bearing for a motor vehicle steering system

(75) Inventors: Jerome Pionnier, Nogent (FR); Sebastien Broise, Langres (FR); Christophe Poinsel, Langres (FR); Bruno Agnus, Chaumont (FR)

Correspondence Address: OLIFF & BERRIDGE, PLC, P.O. BOX 19928, ALEXANDRIA, VA, 22320, US

(73) Assignee: COMPAGNIE PLASTIC OMNIUM, LYON (FR)

(21) Appl. No.: 10/896,120

(22) Filed: Jul. 22, 2004

(30) Foreign Application Priority Data
Aug. 13, 2003 (FR) 03 09897

(51) Int. Cl. F16C 17/04; F16C 33/00; B62D 5/06

(52) U.S. Cl. 384/42; 180/428

(57) ABSTRACT

The present invention relates to a rack thrust bearing for a motor vehicle steering system, the thrust bearing comprising: a shoe forming a friction surface designed to press against a rack of the steering system; and a body, said body comprising: one or more abutment surfaces against which the shoe presses laterally when it is fixed on the body of the thrust bearing; and at least one holding portion in relief arranged so as to hold the shoe on the body of the thrust bearing, bearing against the abutment surface(s), wherein the holding portion in relief includes a peg that is suitable for co-operating with the shoe, and that is flattenable, in particular by die-flattening.

The present invention relates to a rack thrust bearing for a motor vehicle steering system.

### BACKGROUND OF THE INVENTION

Such a system can be of the manual type, possibly provided with hydraulic or electrical assistance.

A steering system conventionally comprises:

a rack;

a steering column with a pinion meshing with the rack; and

a rack thrust bearing including a friction surface designed to press against the rack so as to oppose forces exerted thereon.

In particular, the thrust bearing must be able to withstand significant mechanical forces, must be. sufficiently slippery so as to avoid generating excessive forces as a result of the friction on the rack, and must withstand abrasion.

The thrust bearing may be made in various ways.

By way of example, the thrust bearing may comprise a metal body with a shoe made of thermoplastic material fixed thereon.

The shoe may be rigid, e.g. being made from a metal plate and from polytetrafluorethylene (PTFE), and fixed onto the body of the thrust bearing by stamping.

In the above-mentioned cases, the shoe is generally assembled on the body of the thrust bearing when the steering system is assembled.

The thrust bearing may also have no shoe, the friction surface for rubbing against the rack being formed by a wall of the body of the thrust bearing made of thermoplastic material.

### OBJECTS AND SUMMARY OF THE INVENTION

The invention seeks in particular to improve fixing a shoe on the thrust bearing body, and to enable a wide range of materials to be used in order to make the shoe.

The invention provides a rack thrust bearing for a motor vehicle steering system, the thrust bearing comprising:

a body; and

a shoe forming a friction surface designed to press against a rack of the steering system, wherein the body comprises:

one or more abutment surfaces against which the shoe presses laterally when it is fixed on the body of the thrust bearing; and

at least one holding portion in relief arranged so as to hold the shoe on the body of the thrust bearing, bearing against the abutment surface(s).

By means of the invention, the shoe may be fixed without stamping said shoe, and in order to make the shoe, it is possible to use both rigid and flexible materials, e.g. a flexible material that is unsuitable or poorly suitable for stamping.

The invention also makes it possible for the shoe to be assembled with the body of the thrust bearing at a first production site, and for the thrust bearings assembled in this way to be delivered to a second production site where the steering system is assembled.

In addition, as a result of the presence of the abutment surface(s), it is possible to fix the body of the thrust bearing with a predetermined relative orientation.

In an embodiment of the invention, the shoe may be substantially in the form of a strip with two substantially parallel longitudinal edges, said strip, when it is observed side on, presenting in particular a concave face that faces away from the body of the thrust bearing.

The body of the thrust bearing preferably presents a recess arranged to receive the shoe at least in part, the abutment surface(s) being formed on one or more walls of the recess.

The recess advantageously forms two substantially parallel abutment surfaces against each of which a respective longitudinal edge of the shoe presses.

The holding portion in relief may include a peg that is suitable for co-operating with the shoe, and that is flattenable, in particular by die-flattening, and the shoe may include a tab with a notch into which the peg penetrates, and against which the flattened peg presses.

In a variant, the portion in relief may be elastically deformable, and may be arranged so as to enable the shoe to be put in place on the body by snap-fastening.

In an embodiment of the invention, the shoe includes a thermoplastic material.

In particular, the shoe may comprise an expanded metal sheet and PTFE.

The body of the thrust bearing may be made of a thermoplastic material, in particular by injection molding.

The invention also provides a motor vehicle steering system, comprising:

a rack;

a steering column with a pinion meshing with the rack; and

a rack thrust bearing as defined above, the friction surface of the thrust bearing coming to press against the rack so as to oppose, in particular, forces exerted on said rack.

The invention also provides a method of manufacturing a thrust bearing for a motor vehicle steering system, the method comprising the following steps:

providing a shoe;

providing a thrust bearing body comprising one or more abutment surfaces against which the shoe presses laterally when it is fixed on the body of the thrust bearing, and at least one holding portion in relief arranged so as to hold the shoe on the body of the thrust bearing; and

placing the shoe on the body, said shoe bearing laterally against the abutment surface(s), the holding portion in relief holding the shoe on the body of the thrust bearing.

The holding portion in relief may include a peg that is suitable for co-operating with the shoe, and that is flattenable, in particular by die-flattening.

The peg may be deformed at ambient temperature.

In a variant, the body of the thrust bearing may be heated prior to the peg being deformed.

The peg may also be deformed by means of a preheated tool.

The peg may also be deformed by means of a tool on which ultrasound is generated.

The above-mentioned method may be implemented directly on the production line for rack thrust bearings, in particular by using an assembly peripheral, e.g. with a robot, for assembling the shoe on the thrust bearing body and for die-flattening the pegs.

In particular, this method enables a pre-assembled unit to be delivered, thereby avoiding the need for the client to perform that assembly.

### BRIEF DESCRIPTION OF THE DRAWINGS

The present invention will be better understood on reading the following detailed description of non-limiting embodiments of the invention, and on examining the accompanying drawings, in which:

FIG. 1 is a diagrammatic and fragmentary section view of a motor vehicle steering system;

FIG. 2 is a diagrammatic and fragmentary view of a body of a thrust bearing in accordance with the invention;

FIG. 3 is a diagrammatic and fragmentary view of a shoe designed to be assembled on the thrust bearing body of FIG. 2;

FIG. 4 is a diagrammatic and fragmentary view of the thrust bearing body of FIG. 2 with the shoe placed on top, before the holding portions in relief have been deformed;

FIG. 5 is a view similar to that of FIG. 4, after the holding portions in relief have been deformed;

FIG. 6 is a diagrammatic and fragmentary view of a body of a thrust bearing constituting another embodiment of the invention;

FIG. 7 is a diagrammatic and fragmentary view of a shoe designed to be assembled on the thrust bearing body of FIG. 6; and

FIG. 8 is a diagrammatic and fragmentary view of the thrust bearing after the thrust bearing body of FIG. 6 and the shoe of FIG. 7 have been assembled together.

### MORE DETAILED DESCRIPTION

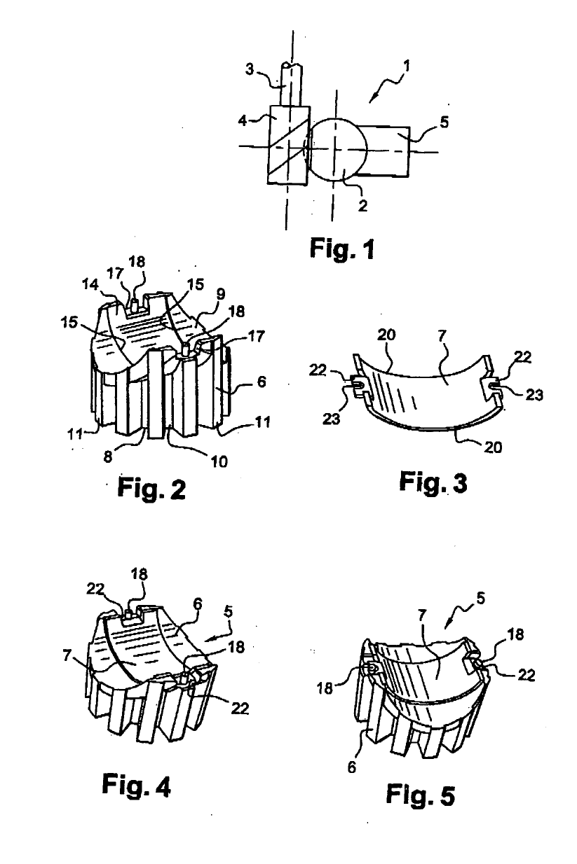

FIG. 1 is a diagram showing various elements of a steering system 1 for a motor vehicle, namely a rack 2, a steering column 3 with a pinion 4 meshing with the rack 2, and a rack thrust bearing 5 pressing against the rack 2.

FIGS. 2 and 3 respectively show a thrust bearing body 6 and a shoe 7, together designed to form a thrust bearing 5 in accordance with the invention.

The thrust bearing body 6 includes a bottom face 8 and a top face 9 between which a side wall 10 extends.

The side wall 10 carries parallel fluting 11 extending between the two faces 8 and 9.

The top face 9 is geometrically defined by the intersection of two cylinders having perpendicular axes, and is concave, facing away from the bottom face 8.

The top face 9 includes a recess 14 with two parallel longitudinal walls defining two abutment surfaces 15.

At each end of the recess 14, the thrust bearing body 6 includes a recess 17 into which there extends a holding portion in relief 18 in the form of a peg that is capable of being flattened by die-flattening.

In the example under consideration, the thrust bearing body 6 is made as a single piece by injection molding a thermoplastic material, in particular filled polyacetal (POM) or filled polyamide (PA).

The shoe 7 is in the form of a strip with two substantially parallel longitudinal edges 20, said strip, when it is observed side on, presenting a concave face that faces away from the body of the thrust bearing.

At each end, the shoe 7 includes a tab 22 provided with a notch 23 into which the peg 18 penetrates before being flattened, and against which the flattened peg 18 presses.

The shoe 7 can be made of thermoplastic material or of a material containing an expanded metal sheet and PTFE, like the material described in the Applicant's European patent EP 0 656 252.

By way of example, the tabs 22 can be formed by cutting and folding the strip forming the shoe 7.

The shoe 7 is assembled on the thrust bearing body 6 by placing the shoe 7 in the recess 14 of the thrust bearing body 6, as shown in FIG. 4.

As can be seen, the shoe 7 is put in place on the thrust bearing body 6 with a predetermined relative orientation.

The shoe 7 can be put in place on the thrust bearing body 6 either manually or automatically.

The pegs 18 are then deformed by die-flattening, enabling them to be flattened on the tabs 22 of the shoe 7, as shown in FIG. 5.

The pegs 18 can be deformed at ambient temperature, or by heating the thrust bearing body 6 prior to the pegs 18 being deformed, or even by deforming the pegs by means of a preheated tool.

The invention is not limited to holding portions in relief that are deformed by die-flattening.

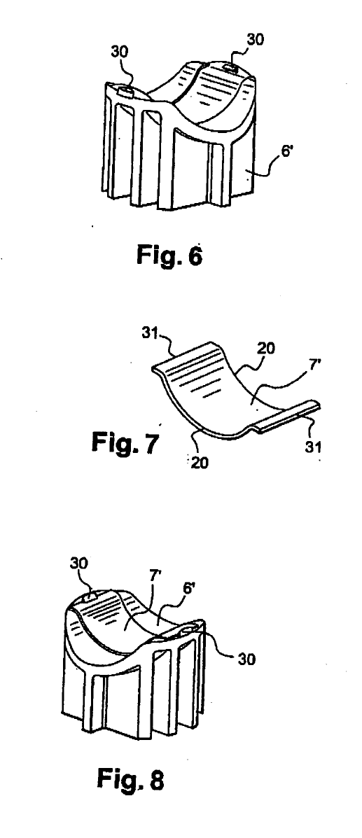

FIGS. 6 to 8 show another embodiment of the invention.

In this example, the thrust bearing body 6′ differs from the thrust bearing body 6 by the fact that it includes, at each end of the recess 14, an elastically-deformable holding portion in relief 30, constituted by a tooth arranged so as to enable the shoe to be put in place in the recess 14 by snap-fastening.

The shoe 7′ shown in FIG. 7 does not have tabs 22 and presents two rectilinear and parallel transverse edges 31.

The shoe 7′ is put in place on the thrust bearing body 6′ by inserting it into the recess 14, and by elastically deforming the holding portions in relief 30.

Naturally, the invention is not limited to the embodiments described above.

In particular, the abutment surfaces 15 need not be provided on walls of a recess, but could be provided on parallel ribs projecting from the top face 9 of the thrust bearing body.

1. A rack thrust bearing for a motor vehicle steering system, the thrust bearing comprising:
a shoe forming a friction surface designed to press against a rack of the steering system; and
a body, said body comprising:
one or more abutment surfaces against which the shoe presses laterally when it is fixed on the body of the thrust bearing; and
at least one holding portion in relief arranged so as to hold the shoe on the body of the thrust bearing, bearing against the abutment surface(s),
wherein the holding portion in relief includes a peg that is suitable for co-operating with the shoe, and that is flattenable, in particular by die-flattening.

2. A thrust bearing according to claim 1, wherein the shoe is substantially in the form of a strip with two substantially parallel longitudinal edges, said strip, when it is observed side on, presenting in particular a concave face that faces away from the body of the thrust bearing.

3. A thrust bearing according to claim 1, wherein the body presents a recess arranged to receive the shoe at least in part, the abutment surface(s) being formed on one or more walls of the recess.

4. A thrust bearing according to claim 3, wherein the recess forms two substantially parallel abutment surfaces against each of which a respective longitudinal edge of the shoe presses.

5. A thrust bearing according to claim 1, wherein the shoe includes a tab with a notch into which the peg penetrates, and against which the flattened peg presses.

6. A thrust bearing according to claim 1, wherein the shoe includes a thermoplastic material.

7. A thrust bearing according to claim 6, wherein the shoe includes an expanded metal sheet and PTFE.

8. A thrust bearing according to claim 1, wherein the body of the thrust bearing is made of a thermoplastic material, in particular by injection molding.

9. A motor vehicle steering system, comprising:
a rack;
a steering column with a pinion meshing with the rack; and
a rack thrust bearing as defined in claim 1, the friction surface of the thrust bearing coming to press against the rack so as to oppose, in particular, forces exerted on said rack.

10. A method of manufacturing a rack thrust bearing for a motor vehicle steering system, the method comprising the following steps:
providing a shoe;
providing a thrust bearing body comprising one or more abutment surfaces against which the shoe presses laterally when it is fixed on the body of the thrust bearing, and at least one holding portion in relief arranged so as to hold the shoe on the body of the thrust bearing; and
placing the shoe on the body, said shoe bearing laterally against the abutment surface(s), the holding portion in relief holding the shoe on the body of the thrust bearing, and including a peg that is suitable for co-operating with the shoe, and that is flattenable, in particular by die-flattening.

11. A method according to claim 10, wherein the peg is deformed at ambient temperature.

12. A method according to claim 10, wherein the body of the thrust bearing is heated prior to the peg being deformed.

13. A method according to claim 10, wherein the peg is deformed by means of a preheated tool.

14. A method according to claim 10, wherein the peg is deformed by means of a tool on which ultrasound is generated.
